(19) United States
(12) Patent Application Publication
(10) Pub. No.: US 2006/0136264 A1
(43) Pub. Date: Jun. 22, 2006

(54) System and method for improved health care access

(75) Inventors: Michael A. Eaton, Waukesha, WI (US); J. Michael Eaton, Waukesha, WI (US); Roy Fredricksen, Delafield, WI (US); Jay Mason, Delafield, WI (US)

Correspondence Address: FOLEY & LARDNER LLP, 777 EAST WISCONSIN AVENUE, SUITE 3800, MILWAUKEE, WI, 53202-5308, US

(73) Assignee: GH Global Health Direct, LLC

(21) Appl. No.: 11/022,571

(22) Filed: Dec. 21, 2004

(51) Int. Cl. G06Q 10/00; G07G 1/00

(52) U.S. Cl. 705/2; 705/10

(57) ABSTRACT

Accordingly to one exemplary embodiment, in a computerized system allowing consumers to view health care opportunities from a plurality of different health care providers, a method comprises providing for viewing a health care opportunity offered by a health care provider. The health care opportunity has a price. The method further comprises adjusting the price of the health care opportunity based on at least one preprogrammed criteria.

### BACKGROUND

Little more than ten years after the managed care revolution of the early- to mid-1990's, skyrocketing health care costs have again pushed policy-makers and employers to look for new tools to more efficiently finance health care delivery.

Emerging very prominently from this renewed push to constrain health care costs is an approach loosely defined as “consumer driven health care” (CDHC) that increases the share of overall costs assumed by consumers and, in some configurations, defines or “fixes” at a sum certain the amount of employer contributions to employee health care costs.

A critical component of CDHC is the proliferation of employer-sponsored health savings accounts (HSA) offering employees a sum certain of dollars that can be applied to health care expenditures on an annual basis. It is anticipated that the use of HSAs combined with increased discretionary spending on health care services will change how providers market to and connect with consumers who previously have had their care choices limited by traditional indemnity insurance plans.

One challenge limiting the utility of HSA's is the lack of a true market for health care services that allows consumers to comparison shop on quality and price, and to purchase and schedule services based on cash or HSA payments. There is no single consumer-focused market that fosters price competition for individuals paying for health services out of HSA's, flex accounts, or paying with cash. As a result, consumers find HSAs to have limited utility, a fact that has impeded their adoption as a potentially effective tool for constraining increases in health care costs.

Likewise, there is no current mechanism allowing physicians and other providers to set and routinely manage and amend prices on their “care inventory” based on the time-sensitivity of visits or the price-sensitivity of the market. Health care pricing is driven by traditional “discounted charges” defined by managed care contracts that lock individual consumers with HSA dollars or cash to spend out of the discounted rates set by managed care contracts.

What is needed is a system and method which addresses these failings in the health care market while meeting the needs of employers, providers and health care consumers by creating a market-clearing mechanism that allows for market-sensitive pricing, informed shopping by consumers and/or the ability to purchase and schedule care based on price, quality and preference. Further what is needed is a system and method which has the power to radically transform health care financing for a growing segment of the population by increasing the functionality and attractiveness of health savings accounts, and, encouraging true price competition among providers.

Further still, what is needed is a system and method which can create a marketplace where consumers can price shop and compare a broad range of health care services ranging from preventive health to diagnostic imaging, ambulatory services and complimentary medicine. In this manner, a renewed focus on the “consumer” part of consumer driven health care can be attained, and the balance of market leverage can be shifted to the smart shopper intent on and incented to manage his or her wellness and health care expenditures.

The teachings hereinbelow extend to those embodiments which fall within the scope of the appended claims, regardless of whether they accomplish one or more of the needs or advantages discussed herein.

### SUMMARY

Accordingly to one exemplary embodiment, in a computerized system allowing consumers to view health care opportunities from a plurality of different health care providers, a method comprises providing for viewing a health care opportunity offered by a health care provider. The health care opportunity has a price. The method further comprises the computerized system adjusting the price of the health care opportunity based on at least one preprogrammed criteria.

According to another exemplary embodiment, in a computerized system for matching a health care request from a consumer with a health care opportunity from a provider, a method comprises providing a user interface to a consumer. The user interface is configured to receive a request from a consumer for a health care opportunity. The method further comprises receiving a health care opportunity from a provider and providing the health care opportunity to the consumer for viewing if the health care opportunity meets the health care request. The method further comprises receiving from the consumer a request to accept the health care opportunity and facilitating payment to the provider of the accepted health care opportunity.

According to another exemplary embodiment, a computer program stored on a computer-readable medium for use by a health care provider comprises a practice management program and an interface program. The practice management program is configured to facilitate management of the health care provider's practice. The interface program is configured to provide communication between the practice management program and a computerized system allowing consumers to view health care opportunities from a plurality of different health care providers.

### BRIEF DESCRIPTION OF THE DRAWINGS

The invention will become more fully understood from the following detailed description, taken in conjunction with the accompanying drawings, wherein like reference numerals refer to like parts, and in which:

FIG. 1 is a flow diagram illustrating a computerized system and method for improved health care access, according to an exemplary embodiment;

FIG. 2 is an exemplary flow diagram illustrating the system and method of FIG. 1 according to an exemplary embodiment;

FIG. 3 is a flow chart illustrating a method of adjusting the price of a health care opportunity in a computerized system, according to an exemplary embodiment;

FIG. 4 is a flow chart of a method of providing a health care program to a consumer, according to an exemplary embodiment;

FIG. 5 is a block diagram of a computer program for integrating a practice management program with an interface program, according to an exemplary embodiment;

FIG. 6 is a flow chart illustrating an example of one embodiment;

FIG. 7 is a flow chart of an example of another embodiment;

FIG. 8 is a flow chart of an example of another embodiment;

FIG. 9 is a flow chart of an example of another embodiment;

FIG. 10 is a flow chart of an example of another embodiment; and

FIG. 11 is a flow chart of an example of another embodiment.

### DETAILED DESCRIPTION OF EXEMPLARY EMBODIMENTS

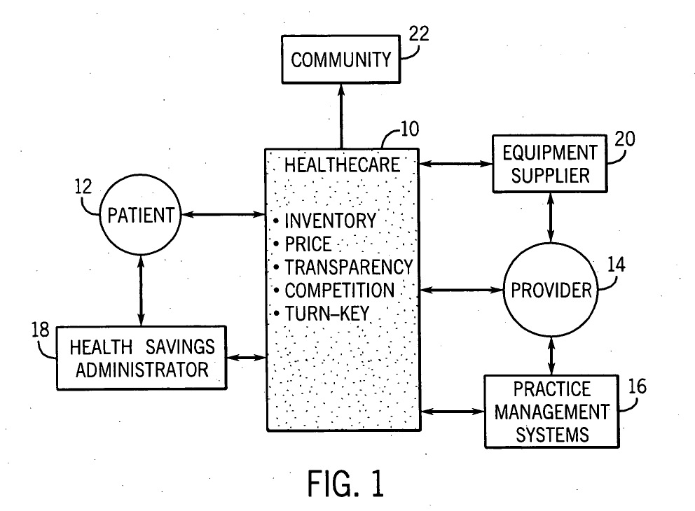

Referring to FIG. 1, a computerized system 10 is shown which allows consumers 12 to view health care opportunities from a plurality of health care providers 14. Health care opportunities can include diagnostic imaging, ambulatory health care services, executive fitness programs, pharmaceuticals, complimentary and alternative medicine, routine and preventive scheduled medical procedures, dental care, packaged health care programs, desirable medical equipment, home health care services, etc. In this exemplary embodiment, computer system 10 is a computer server operating one or more computer programs or applications which provide one or more of the functionalities described herein. In alternative embodiments, one or more of the functions described herein can be provided in whole or in part by a computer (e.g., client computer) associated with provider 14, such as a practice management system 16, a computer associated with health savings administrator 18, a computer associated with a medical or health equipment supplier 20, a computer associated with consumer 12 (e.g., a patient, customer, etc.), or even another party. In this exemplary embodiment, computer system 10 communicates with computers associated with entities 12-20 and perhaps even computers associated with the community 22 using a hypertext machine language (HTML), web-based language. Alternatively, any other form of wireless or wired communication can be used among elements 10-22, such as a dial-up modem, cellular networks, personal area networks such as the IEEE 802.11b, g networks, satellite, cable, digital subscriber line (DSL), or other communication media, in any of a plurality of different computing languages or protocols.

As indicated at system 10, the system has numerous capabilities which will be described in greater detail herein, and can include storing and inventory of health care opportunities, which may include health care services or health care goods, such as pharmaceuticals. System 10 further stores price information for the health care opportunities and provides functionality for adjusting the price of the opportunities. System 10 may provide other features, such as transparency between one or more consumers 12 and one or more providers 14, competition among providers 14 or even among consumers 12, and may further provide a turnkey solution for provider 14 to integrate with an existing practice management system 16 or to health savings administrator 18 to integrate with their software.

Consumer 12 is typically an individual, but could alternatively be groups of individuals or organizations having an interest in viewing, scheduling, receiving, and/or purchasing a health care opportunity. Consumer 12 can access system 10 from a home computer terminal, office computer, laptop, personal digital assistant, mobile phone or other computer.

Provider 14 can be an individual doctor, physician or other health care service provider, such as a trainer, nutritionist, health care system, hospital, etc. who can access system 10 via a home or office computer directly or via an existing practice management system 16. Practice management system 16 can be a computer program configured to assist provider 14 in managing a health care practice, which may include appointment scheduling, accounts receivable and payable, payroll, and/or other functions, such as those systems provided by Epic Systems Corporation of Madison, Wis., Cerner Corp. of Kansas City, Mo., General Electric Company, or others.

Health Savings Administrator 18 can be any financial, benefits, health care or other administrator having one or more computer systems, often associated with businesses providing benefits to their employees and managing health savings accounts, medical savings accounts or flexible savings accounts for employees, such as systems provided by Fortis of Brussels, Belgium, Principal Financial Group of Des Moines, Iowa, FlexBen, Medavante, Fiserv, or even investment or brokerage firms such as Fidelity or Schwab. Health Savings Administrator 18 can be one or more different entities associated with consumer 12, for example where one entity may manage a health savings account for consumer 12 and another entity may provide benefits administration services for consumer 12.

Equipment supplier 20 can also access system 10 to offer health care products for sale or bid via system 10 to consumer 12 or provider 14.

System 10 is configured to perform one or more functions relating to connecting consumers 12 with providers 14. In some embodiments, system 10 connects consumers 12 with providers 14 in a competitive, web-based, public marketplace. In some embodiments, system 10 can facilitate payment from a health savings account associated with consumer 12 or from a cash account, such as a bank account or credit card account, or even from a regulatory program or a discretionary income source to provider 14 via system 10.

According to one advantageous embodiment, system 10 allows consumers to view health care opportunities from a plurality of different health care providers 14. Consumer 12 may access system 10 via a web site maintained by system 10 which can be funded, supported, or marketed by one or more health saving administrators, employers, unions or government-sponsored programs, or other persons. Health care opportunities are provided for viewing by consumer 12 by displaying, for example, the health care opportunity, price, time, and location, qualifications of the health care provider, feedback from other system users or other sources of credentials for providers 14, proximity or location, volume of services provided and other information allowing consumers 12 to compare health care opportunities from one or more providers on the basis of these factors. According to a further advantageous embodiment, system 10 allows consumer 12 to purchase and schedule health care opportunities via system 10, for example with a single click on a displayed health care opportunity icon or display element, thereby making the cost of services transparent, competitive and accessible. According to some embodiments, consumer 12 can pay “on line” or via system 10 for the services directly through a health savings account or other account managed by health savings administrator 18 or by providing credit card information, check card information, or information regarding other sources of income.

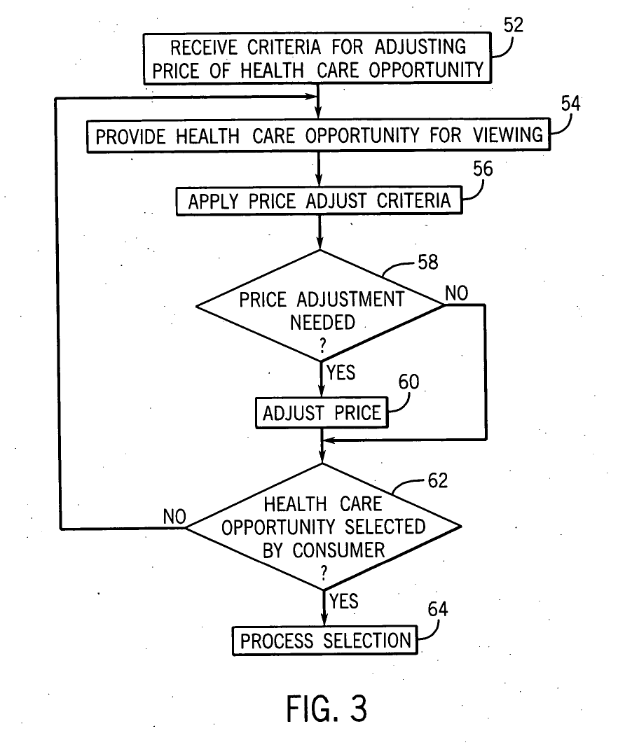

According to one advantageous embodiment, practice management system 16 can include an interface program or module designed to communicate between system 10 and a practice management module or modules, as will be described in greater detail herein with reference to FIG. 5. In this manner, provider 14 can communicate an inventory of health care opportunities and select which of said opportunities are to be discounted or otherwise priced. According to a further advantageous embodiment, system 10 can allow provider 14 to input one or more criteria to system 10 which will affect the price of one or more of the health care opportunities for example based on time or market-based criteria, as will be described herein with reference to FIG. 3. Consumer 12 can then view health care opportunities and select an appointment, and practice management system 16 can receive data representing the appointment or request from consumer 12 and update an appointment calendar on practice management system 16.

After the health care service or good is provided by provider 14, practice management 16 can invoice system 10 and system 10 can facilitate payment from consumer 12's account, for example via health savings administrator 18, by providing electronic payment (e.g., ACH debit or other electronic payment) to provider 14 via practice management system 16. Furthermore, system 10 can calculate a fee to be retained by the operator of system 10, which can be based on the price of the health care service rendered.

In some embodiments, system 10 facilitates the use of health savings accounts and provides opportunities for consumers 12 to use their health savings accounts more effectively and in a competitive environment. In some embodiments, system 10 may enhance HSA functionality by integrating HSA's with tools and functions allowing consumers to compare and purchase on the basis of price, access, quality, and other criteria or factors such as age, gender, education, language, etc.

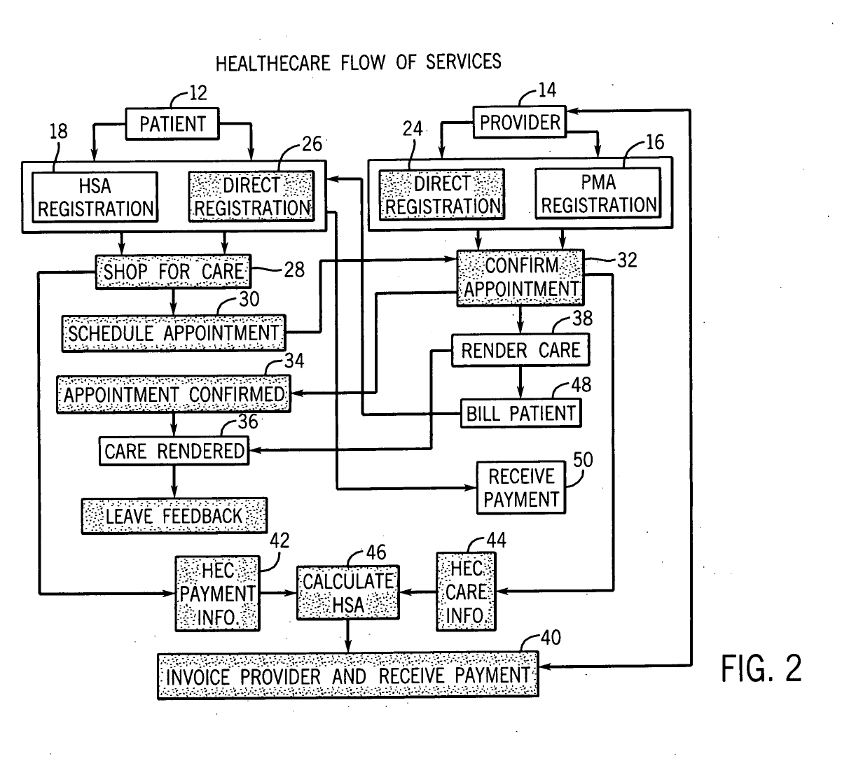

Referring now to FIG. 2, a flow diagram illustrating exemplary functionality of system 10 is shown. Those functions having a shaded box are functions which may be performed by system 10, and in some embodiments, one or more of these functions may be performed by multiple computers operated by one or more different persons or entities. The flow diagram of FIG. 2 illustrates two exemplary methods provider 14 can use to access system 10. Provider 14 may register by providing certain information to a software module (such as an interface module) in their practice management application 16. In an alternative embodiment, provider 14 can perform direct registration 24, for example by using a standard web browser, such as Internet Explorer or Netscape Navigator, to provide registration data to system 10 through the web browser. Direct registration 24 can also take place via a dial up connection or by filling out a paper form and mailing or faxing it to an administrator of system 10, who will then enter the registration information into system 10. System 10 can be configured to receive certain registration data, such as the provider name, office location or locations, and payment information, which can include agreed-upon discounts on some or all of the services provided by provider 14, billing information, such as account information, ACH debit information, etc., the types of services or the types of health care opportunities provided by provider 14, balance billing, or other information. Upon registration or other agreement process, system 10 is configured to receive health care opportunity inventory and discounts from provider 14.

If practice management application 16 has an interface module or program for system 10, the interface module can periodically, automatically or in response to provider request, upload data from system 10 representing new appointments selected by consumers 12 and remaining inventory of health care opportunities.

System 10 is configured to receive registration information from consumer 12 in any of a number of ways, including registration through a health savings administrator 18, which may include a paper application or receiving data electronically via a web interface or the like, or via direct registration, for example, where consumer 12 can access system 10 via a web browser or other interface. System 10 is configured to provide a user interface to allow consumer 12 to input information about the consumer, which may include name, address, health savings account information, checking or savings account information, credit card information, etc.

Once a consumer 12 is registered, consumer 12 may log in to system 10, and system 10 provides the user interface to consumer 12 allowing them to view health care opportunities and shop for care 28. System 10 is configured to provide a plurality of health care opportunities, each opportunity comprising associated data representing one or more of the provider's name, geographic area or areas, address, dates and times of services, discounts, prices, patient feedback, etc. As shown in FIG. 1, some or all of this information can be made available by system 10 for viewing by the community 22, which can include persons who have not registered either as a patient or provider with system 10. At step 30, system 10 is configured to receive a request from consumer 12 to schedule an appointment, consumer 12 having selected a health care opportunity. According to one embodiment, system 10 may prompt provider 14 to confirm acceptance of the appointment at step 32. Alternatively, practice management system 16 may automatically confirm appointment 32 without input from provider 14 and may further automatically schedule consumer 12 on a calendar module of practice management system 16.

System 10 is configured to provide a confirmation 34 to consumer 12. System 10 can send the confirmation via an e-mail to an e-mail address associated with consumer 12. Alternatively, system 10 can display the confirmation status to consumer 12 upon consumer 12 logging in to system 10. Advantageously, if the appointment is more than a pre-determined time away from the current time and day, system 10 can be configured to send one or more reminder e-mails, or even facsimile, pager, or other communication, as a reminder of the appointment.

Steps 36 and 38 represent consumer 12 receiving the health care good or service from provider 14. System 10 can then be configured to facilitate payment from consumer 12 or one of consumer 12's accounts to provider 14 or one of provider 14's accounts. According to one exemplary method, practice management system 16 can be configured to submit an electronic bill or other request for payment to system, 10 as shown at step 40, representing provider 14 invoicing system 10. System 10 is configured to receive payment information at step 42 from consumer 12. For example, system 10 can receive payment preference from consumer 12 at the time of scheduling appointment 30 or during registration 18, 26. System 10 can further be configured to receive information about the appointment at step 44 and to calculate the proper debit, applying any pre-determined discount or other price adjustment at step 46. System 10 is then configured to submit the charges to the proper account associated with consumer 12, which is preferably done electronically but alternatively can be done using other billing methods. System 10 receives payment electronically and forwards payment to provider 14, again either electronically or using other payment method. System 10 can further be configured to reduce the amount paid to provider 14 by a service fee retained by system 10 and the administrator thereof. System 10 is configured to facilitate payment in these or alternative methods.

In an alternative embodiment, provider 14 may bill patient 48 in a conventional manner and receive payment 50 in a conventional manner.

According to a further advantageous feature, system 10 can be configured to e-mail a survey or other request for information to an e-mail account associated with consumer 12 in order to solicit information regarding the care provided, the provider, system 10, or other useful information. System 10 can be configured to store and report (e.g., via display or printout) tabulated information for provider 14, consumer 12, and/or community 22.

According to one advantageous feature, system 10 can be configured to calculate the funds remaining in a health savings account or other account associated with consumer 12 and, if a payment exceeds that amount, system 10 can be configured to debit checking or savings accounts or other accounts of consumer 12 for charges in excess of the health savings account balance. System 10 can further be configured to offer a credit line to consumer 12 at an agreed upon interest rate.

System 10 can further be configured to provide periodic reports electronically or via paper to provider 14, for example via practice management system 16 or directly 24 showing utilization and remaining unused inventory, which may also include a suggested discount which may improve provider 14's opportunities to use unused inventory. A suggested discount can be based on statistics collected by system 10 from health care opportunity data stored for one or more of providers 14, scheduled appointments processed, payments processed, consumer surveys data, etc.

System 10 can further be configured to display for viewing discounts on health care opportunities from other providers showing the pricing distribution range for all health care opportunities, health care opportunities filled and unfilled, health care opportunities in certain categories, etc. System 10 can provide a user interface to provider 14 to allow searching and sorting of this data.

According to another exemplary embodiment, a method of providing market data to a health care provider comprises providing for viewing a plurality of health care opportunities from different health care providers receiving a plurality of request from consumers to purchase the health care opportunities, storing data regarding the purchased health care opportunities, and providing a summary of the data for viewing. For example, the data can include price.

According to another exemplary feature, system 10 can be configured to receive a request from consumer 12 for a health care opportunity at a price, location, or based on other criteria, which is a consumer request for a health care opportunity or program, and can include a request for an alert from system 10. System 10 can be configured to match the health care request from the consumer (e.g. for a health care opportunity or a health care program comprising a plurality of health care opportunities directed to a predetermined health-related outcome or outcomes) with a health care opportunity from a provider (which can be received by system 10 prior to receiving the consumer request or in response to the consumer request). System 10 can provide a user interface to a consumer configured to receive a request from a consumer for a health care opportunity (e.g. via a web page or form). System 10 can query pre-stored inventory of health care opportunities for opportunities meeting the one or more criteria associated with the consumer request. Alternatively or in addition, system 10 can forward a request (or the consumer request) to one or more health care providers in an attempt to solicit health care opportunities which may meet the criteria associated with consumer requests. System 10 can identify, compare, or match health care opportunities with the health care request criteria provided by the consumer and provide one or more health care opportunities meeting the criteria to the consumer for viewing based on the match process. System 10 can be configured to receive from the consumer a request to accept the health care opportunity, for example by the user clicking on a display element of a user interface. System 10 can further be configured to facilitate payment to the provider of the accepted health care opportunity. System 10 can be configured to notify or alert consumer 12 by electronic mail or by displaying a notification upon log-in by consumer 12 to system 10, or by another alert method (e.g., phone call, pager, fax, etc.) that the request has been met, and system 10 can then be configured to schedule an appointment in response to a click from consumer 12 and to facilitate payment to provider 14.

System 10 can be configured to provide consumer 12 the opportunity to enter certain account preferences to allow consumer 12 to customize the user interface provided by system 10 to consumer 12. For example, account preferences can include whether consumer 12 wishes to be prompted to provide feedback or survey data on provider 14, a field for receiving a list of providers consumer 12 has received care from and/or feedback on such providers, whether system 10 should provide a user interface to receive a consumer request for a health care opportunity at a preferred price, the information for an account or accounts associated with consumer 12, fields to receive profiling for a medical condition associated with a consumer 12 such that system 10 can send periodic e-mails or displayed reminders for health care services consumer 12 should be having at pre-determined intervals of time, for example based on age and condition, or other account preferences.

Referring again to FIG. 1, community access 22 is provided by system 10 to allow persons to register with system 10 so that they can view data relating to health care opportunities, for example by geographic location, by volume or type of health care opportunity, by volume of health care service or good for provider, discount ranges for health care opportunity types, and other information stored in system 10.

According to another exemplary feature, system 10 can provide certain data to employers, unions, governmental entities, etc. based on utilization by employees of system 10 and data stored by system 10. This data can be used to track and understand the relationship between health inputs and individual and community health measures and outcomes.

System 10 can provide numerous features to the various entities shown in FIG. 1. For example, health savings administrator 18 can use system 10 to verify the eligibility of health savings account information provided by consumer 12 to system 10. System 10 can further be configured to provide payment data to health savings administrator 18 for services rendered such that health savings administrator 18 can make payment to system 10.

Practice management system 16 can be configured to have an interface program or module configured to provide confirmation of a scheduled appointment to a consumer via system 10 and to update an appointment schedule on practice management system 16 for provider 14 based on a confirmed appointment 32. Practice management system 16 can further be configured to receive data from system 10 representing health care services rendered to consumers 12 over a period of time.

System 10 can be configured to allow community 22 to view price ranges for area health care opportunities, to view utilization of inventory stored in system 10 by provider 14, to review health care services provided globally, to view regional data regarding consumers served by system 10, and to view or browse other data.

System 10 can further be configured to provide a tutorial to consumer 12 which will assist consumer 12 in learning how to view, shop for, schedule, and pay for health care opportunities. System 10 is configured to provide data to consumer 12 allowing consumer 12 to search for health care opportunities based on location, price, feedback, time, etc. System 10 can be configured to allow consumer 12 to schedule an appointment on-line, receive a discount applied by provider 14, etc. System 10 can further be configured to process payment by authorizing payment from a cash account, health savings account, or other account. System 10 can further be configured to receive feedback regarding the care from consumer 12, allow consumer 12 to search for care in the future (e.g., weeks, months in advance), review a history of health care opportunities received by health care services or products received, and further provide information to consumer 12 to allow consumer 12 to understand and manage medical conditions.

According to a further exemplary embodiment system 10 can be configured to identify that the geographic location of a health care service selected by consumer 12 is in a geographic location a pre-determined distance from consumer 12's home or office location or address. In response, system 10 can be configured to provide a user interface to consumer 12 allowing consumer 12 to search for, select, and/or pay for travel, lodging, entertainment, meals, visa acquisition for international travel, and other travel-related needs. According to a further advantageous embodiment, system 10 can automatically provide a user interface linking consumer 12 to a travel-related service (e.g., expedia.com, or launch a phone call to a travel agency) upon one click of a cursor on an icon or other graphic element which confirms consumer 12's request to schedule an appointment for a health care opportunity. Alternatively, one click from an appointment-scheduling icon can provide one or more trademark icons for various travel-related providers. Travel-related providers can include air, rail, sea transport, local ground transportation, shuttles, rental cars, lodging, meals, entertainment, etc. Furthermore, provider 14 can associate on system 10 a discounted or complimentary travel-related opportunity in conjunction with the health care opportunity.

System 10 is also configured to provide various features for provider 14. According to one exemplary embodiment, system 10 can provide a user interface configured to receive profile information and/or a fee schedule from provider 14, which may include the provider's specialties, background, education, number and type of health care procedures completed, etc. System 10 can further be configured to provide a user interface to provider 14 to assist in creating a discount model for pricing, which will be described in greater detail with reference to FIG. 3 herein. System 10 can be configured to receive health care opportunities through practice management system 16 or directly from provider 14, for example, through a web browser.

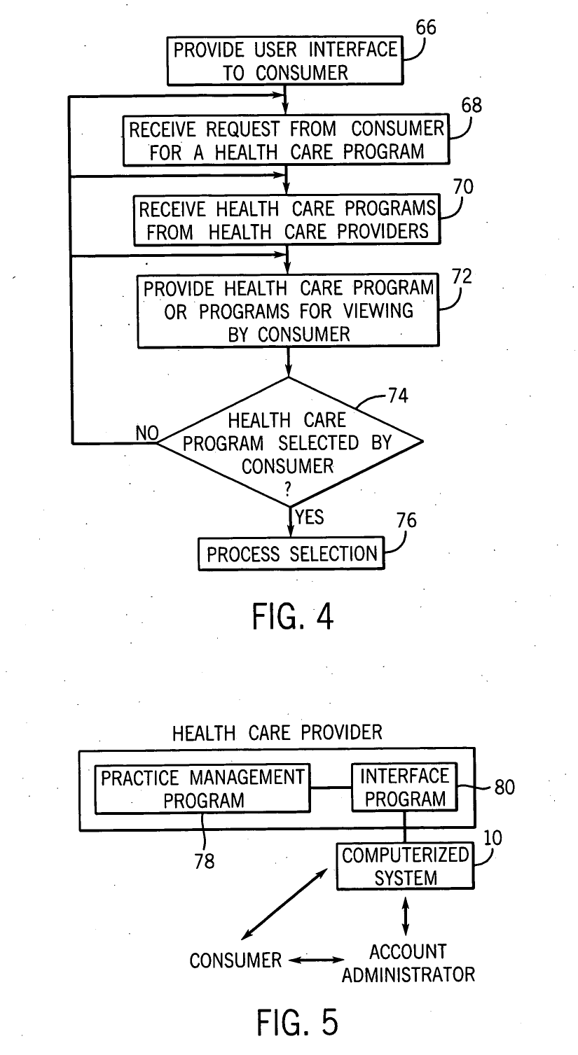

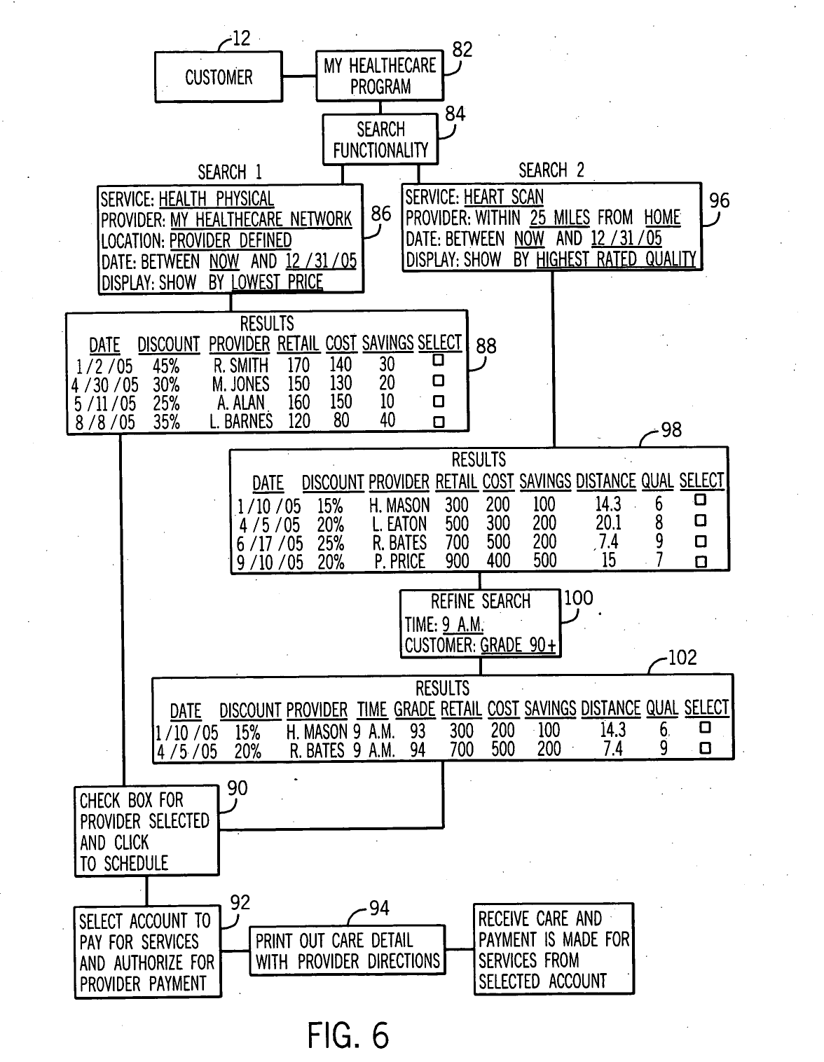

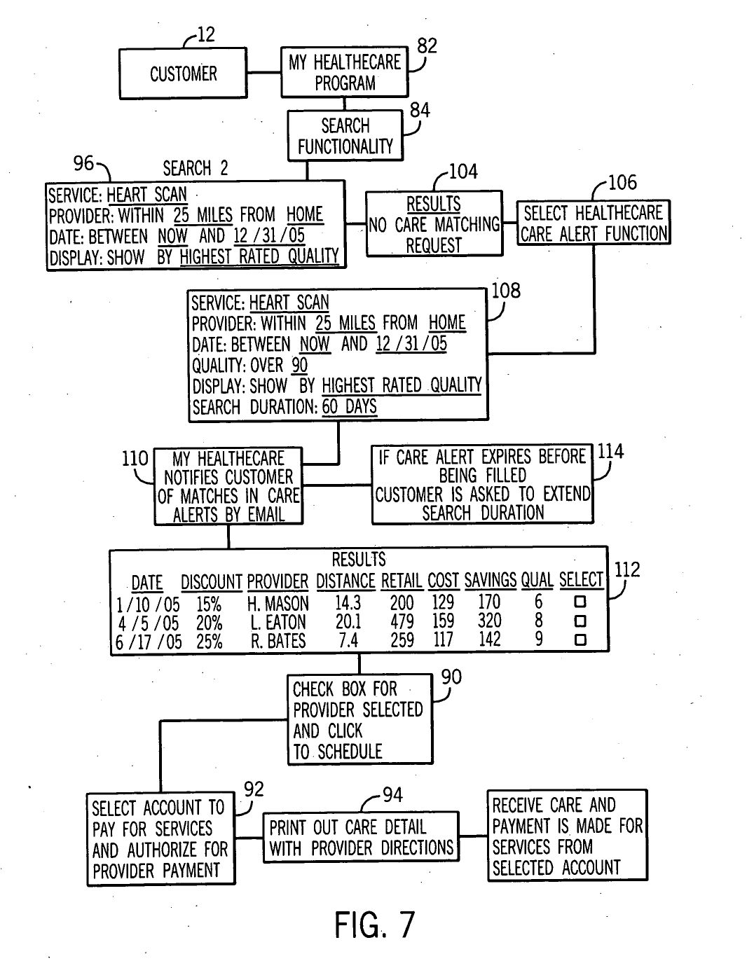

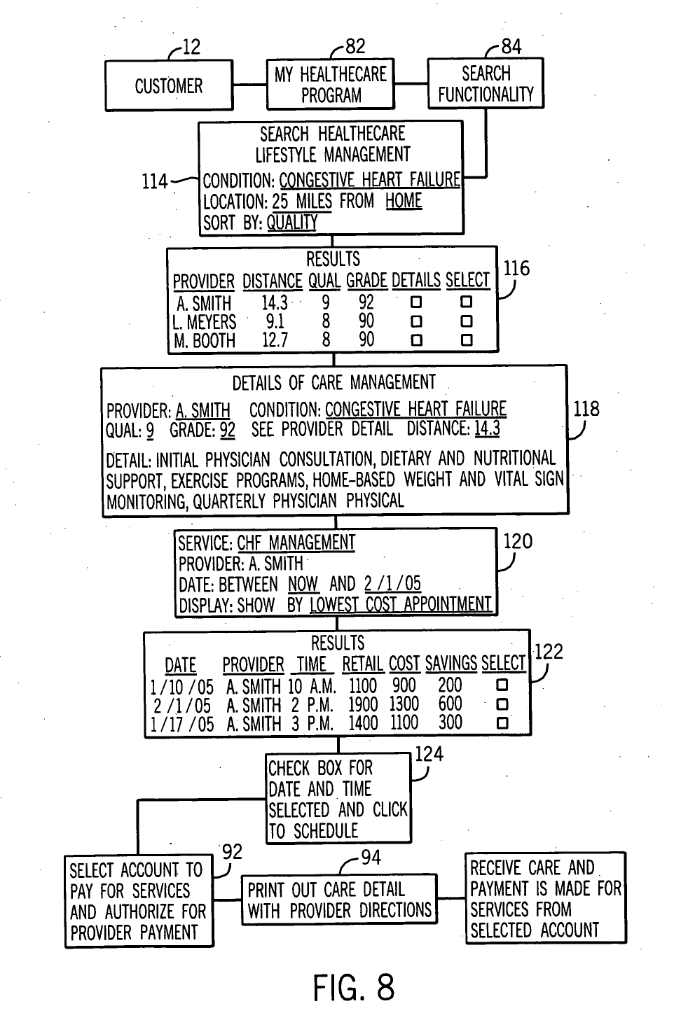

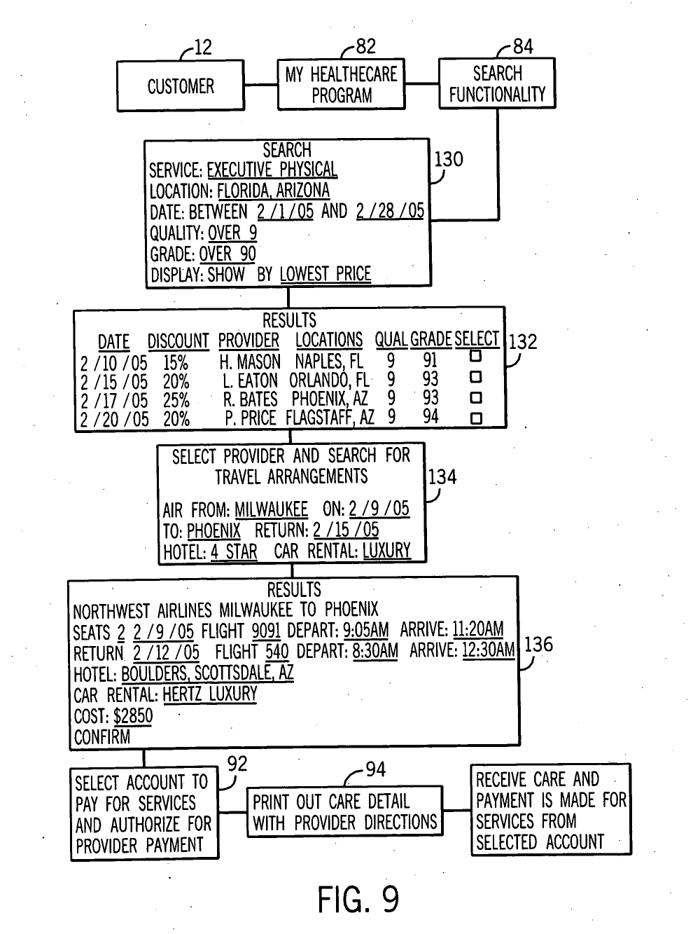

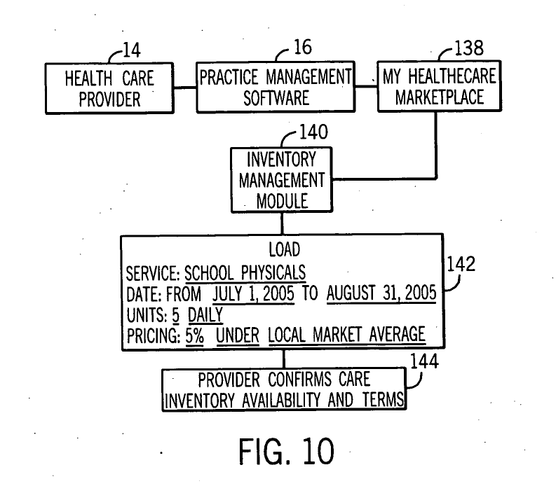

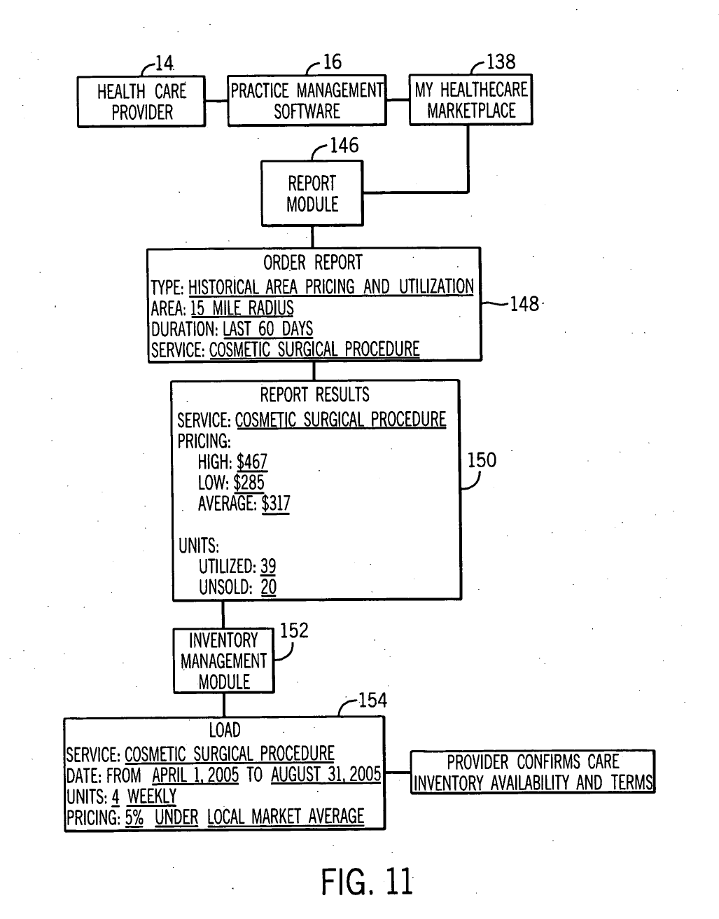

System 10 can further be configured to provide advertising or marketing functions for provider 14 in an effort to fill unused inventory (stored on system 10). System 10 can further allow provider 14 to view, search for, and select requests from consumers 12 for health care services, and further may offer bundled services or a health care program, as will be described herein with reference to FIG. 4.

Referring now to FIGS. 3 and 4, flow charts illustrating exemplary features will now be described. The functions shown in FIGS. 3 and 4 can be part of a larger function, program, or application, and the steps thereof may be interchangeable. At a step 52, system 10 is configured to receive one or more criteria for adjusting the price of a health care opportunity provided to consumers viewing system 10. The criteria is preprogrammed and affects an initial price of the health care opportunity which can be set by provider 14. The criteria can be a time-based criteria. For example, system 10 can be programmed to automatically (i.e., without the provider having to manually change the price) adjust the price of the health care opportunity downward by a preprogrammed dollar amount or percentage, a predetermined time (e.g., 24 hours, 48 hours, one week, two hours) before an appointment date and time associated with a health care opportunity. The preprogrammed criteria can be specified by provider 14, for example, by typing in “24 hours,” or provider 14 can chose a preprogrammed time-based model specified by system 10, for example, preprogrammed parameters adjusting the price of the health care opportunity at a plurality of predetermined time intervals away from the appointment date and time of the health care opportunity. The preprogrammed parameters (or criteria or model) can be linear or nonlinear.

According to another example, the preprogrammed criteria can be a market-based criteria and the price of the health care opportunity is adjusted based on a supply of or demand for other health care opportunities provided for viewing in system 10. For example, a market-based criteria could be to maintain the price of the health care opportunity at always the lowest price for the same health-care opportunity type (e.g., a CT scan reading, a physical, etc.) provided by other providers, or only for the same health-care opportunity type having a similar quality characteristic (e.g., as determined by consumer feedback or surveys, credentials, years of experience, association memberships, certifications, etc.). Another example of a market-based criteria is to always maintain the price at a predetermined percentage higher or lower than the highest/lowest price of comparable services (e.g., in type, price, quality, or other characteristics) or to maintain the price at a predetermined percentage below the average price of comparable services. Provider 14, again, may specify the criteria or may select one or more of a plurality of preprogrammed models available in system 10. Provider 14 can provide one criteria or set of criteria for one health care opportunity or type of health care opportunity and may set a second, different criteria or set of criteria for another health care opportunity or type of health care opportunity.

According to another advantageous feature, system 10 can provide a periodical (e.g., weekly or monthly, etc.) report on utilization of inventory of health care opportunities from a provider and include a suggested preprogrammed criteria for a suggested discount model.

According to one advantageous feature, the user interface can be provided to provider 14 having slider buttons which can be clicked and slid in one or more directions to provide input on the predetermined percentages or times of the criteria desired.

At step 54, in this example, after criteria are received for a health care opportunity, a health care opportunity is provided for viewing to consumers. The criteria are monitored at step 56 and applied to adjust the price. At step 58 if a price adjustment is needed, the price is adjusted at step 60. However, if the criteria for adjusting price have not been triggered, the method continues after step 60. At step 62 system 10 is configured to determine whether the health care opportunity has been selected by a consumer and if not, the process can return to step 54. If the health care opportunity is selected by consumer 12, the flow proceeds to step 64 where the selection is processed (i.e., scheduled, payment, etc.), as described herein with respect to FIG. 2.

Another example of a criteria is the number of a health care opportunities sold by a particular provider. In this manner, a provider can use automatic price adjustments to control the quantity of health care services or products provided in a period of time. For example, provider 14 can preprogram a criteria that determines when a predetermined number of a health care opportunity is sold (e.g., which may be a fixed number or which may be a number relative to another number such as the number sold in a previous month, previous year, average sold over a period of time, etc.) and, when the number exceeds the preprogrammed number, the price can be adjusted upward by a certain percentage.

Another market-based criteria can be the average price of similar health care opportunities and the criteria can be to increase or decrease the price of a provider's health care opportunity based on a predetermined percentage of the average price increase or decrease of similar health care opportunities. For example, the provider may select preprogrammed criteria to increase the price of the health care opportunity by 80% of the average price increase but only 20% of the average price drop of comparable health care opportunities.

Another exemplary criteria can be a changing criteria which responds to a health care provider's desire to sell a certain number of units at a target price. For example, a health care provider wishes to sell 1,000 units of a health care opportunity at $200 per unit. The price can be decreased at certain times in order to move inventory but can be increased toward the end of a period such as a quarter or a month to try to achieve an overall average price related to the predetermined dollar figure.

System 10 can provide any number of functions to assist in preparing the criteria, such as preprogrammed criteria or models, profiles to ask questions of the provider which can then be used to generate a preprogrammed or customized model, etc.

Criteria can include pricing relative to market (e.g., at, above, or below market by predetermined percentages or dollars), price sensitivity (e.g., prices will increase or decrease relative to time and marked-based criteria), price maximums and minimums, and quality indicators. According to another exemplary embodiment, system 10 can provide a user interface profile form that can receive price-adjust profile data from provider 14, such as, whether provider wishes to be market aggressive, price aggressive, time aggressive or less aggressive in any of these criteria.

Referring now to FIG. 4, another exemplary feature of system 10 is shown. FIG. 4 is a flow diagram of a module or function to be performed on system 10. At step 66, a user interface is provided to consumer 12 configured to receive a request from a consumer for a health care program. The health care program can be a service, product, or set of services and products packaged or proposed by a health care provider to address a condition or need of consumer 12. At step 68, system 10 receives a request from consumer 12 for a health care program. At step 70, system 10 is configured to receive at least one health care program comprising a plurality of different health care services submitted by one or more health care providers in response to the request. Providers 14 can view consumer requests for health care programs on system 10 and provide a package of services to address the consumer's need. At step 72 provider 14 provides the health care program including data regarding the program or programs for viewing by consumer 12. The health care program data can include the type of service or services, dates and times of proposed services, etc. At step 74 consumer 12 can select from among the programs, and at step 76 the selection can be processed in the manner described hereinabove in FIG. 2 or in another manner. If no program is selected by consumer, flow may continue back to step 68 for the consumer to revise or renew the request, to step 70 where a consumer 12 can wait for additional health care program proposals, or to step 72 where a consumer can continue browsing existing health care program proposals.

For example, a health care program can be directed to managing a chronic condition. A health care program can be directed to improving general health. A health care program can be customized and specified by the consumer.

According to one example, a consumer may request a program to help manage cholesterol. Provider 14 may propose a health care program including quarterly physicals, regular cholesterol checks, a periodic stress test, a pharmaceutical prescription, executive fitness program, etc.

Referring now to FIG. 5, FIG. 5 is a block diagram illustrating another advantageous feature according to an exemplary embodiment. In this embodiment, a practice management program 78 is in communication with an interface program 80. Practice management programs can be configured to facilitate management of a health care providers practice. Interface program 80 can be configured to provide communication between the practice management program and computerized system 10. Advantageously, program 78 and 80 can be integrated. For example, the two programs or modules can share a common user interface, a common look and feel of a graphical user interface, and/or can share a functionality or communicate among each other, such as appointment scheduling, billing, etc. In this embodiment, module 78 and 80 are provided on a computer-readable medium, such as a CD-rom, DVD, disk drive, server, floppy disk, zip disk, RAM, or other memory. For example, interface program 80 can be configured to provide health care opportunities from practice management program 78 to a computerized system 10. Interface program 80 can be configured to facilitate electronic transfer funds from a consumer account on computerized system 10 to an account associated with the health care provider, for example which may be managed by program 78. According to another example, interface program 80 can be configured to provide clinical results to a consumer via a computerized system 10 (e.g., via e-mail). Alternatively, consumers or providers can access computerized system 10 directly via a web browser.

According to another exemplary feature, system 10 can be configured to provide a user interface allowing consumers to select or assemble consumer health management programs or networks of providers. A consumer can access a template for selecting or assembling custom health management programs or networks of providers by clicking on a trademark icon displayed on the system. The consumer can select the programs or networks based on the relative experience of the providers and the success of their programs in achieving desired clinical or lifestyle outcomes.

The following examples demonstrate features and advantages of some embodiments of system 10.

### EXAMPLE 1

Consumer 12 has made a decision to schedule an annual physical exam for herself to include a CT heart scan. She intends to pay for the exam out of funds from an individual health savings account associated with health savings administrator 18 and use a credit card for the CT heart scan. She does not have a set time frame for getting the physical and heart scan done other than wanting to have it scheduled prior to the end of the calendar year.

The consumer logs into an account on system 10, operable on system 10, at step 82, and fills out a search form 84 to purchase a health physical and CT heart scan. The application 86 (operable on system 10) queries her on the following items:
whether she has a preferred provider for the service. She enters the name of a pre-saved list of providers she has selected and maintained called “MyHealtheCare Network,” which includes her existing primary care physician or physicians (PCPs or hospitals) for the health physical, but no preference for the CT heart scan;
how far she is willing to travel for the CT heart scan and she indicates a radius of 25 miles (in the case of the Health Physical search she has already selected the location by selecting her PCPs, though she can further specify one of a plurality of office locations made available by her PCPs); and,
the time frame she would like to have the physician and CT scan done. She indicates prior to year end.
sort physical by lowest price and CT by highest rated quality characteristic

The application searches the data base of physician inventory for health physicals or providers 14 entered by the primary care physicians (“PCPs”) in her pre-saved list and returns a series of options 88. Based on the pricing formulary, model or criteria entered by her primary care physician, she finds that her PCP has a physical available the following day (Jan. 2, 2005) at a deep discount (45%). Alternatively, her PCP has a physical available in approximately 120 days at a lesser discount, and one at the end of the year at a deep discount. The consumer selects 90 the next day (Jan. 2, 2005) and schedules the visit, authorizing payment 92 from her HSA. The consumer prints out a confirmation form 94 for her records.

The application searches 96 the database of physician inventory for CT heart scans and returns multiple providers and dates meeting her criteria 96 in the geographic radius she selected. System 10 is configured to receive one or more locations (e.g., addresses) from the consumer, such as home, work, spouse's work, vacation home, etc., during an account registration process. System 10 prompts the consumer at step 96 to choose one of the locations (e.g., home) to use for vicinity determination.

Prompted to refine her search 100, the consumer indicates that she would like to do the scan prior to 9:00 a.m. on a weekday at a location that has a consumer satisfaction score (an exemplary quality characteristics) about the 90^{th} percentile. Two options are returned 102. The consumer selects one of the options 90, schedules the visit, selects which accounts the care is to be paid from 92, and prints out a confirmation for her records 94 which includes driving directions to the place of care.

### EXAMPLE 2

Same situation as example 1, except the consumer does not find a CT heart scan meeting the terms she has requested 104. The consumer has the option to request a multi-variable alert 106 based on any combination of conditions. In this case the consumer queries the HealtheCare Alert function 108 to notify her by email within 60 days that there is a CT heart scan at or below the initial price that she is willing to pay and is also in the range of quality in which she has identified. When her requests are satisfied 110, she is notified by an automated email of the query match and is directed to the point of purchase 112 on system 10.

However, if after sixty days (or any other predetermined time frame or period) there is still no query match for the consumer, she can also be notified 114 to log into her consumer account and extend or redefine her alert/request specifications or criteria.

### EXAMPLE 3

Consumer has a diagnosis of congestive heart failure and is looking to achieve an outcome of reduced hospitalizations and improved activity of daily life (ADL) functionality. Consumer logs into his account on system 10 and selects a button relating to care management of chronic conditions, which button can have a trademarked icon associated therewith.

Consumer is queried by the application for choice of provider and indicates no preference. He is then queried on how far he is willing to travel for service and indicates a radius of 25 miles 114. The application searches for congestive heart failure (CHF) management programs which have been pre-stored by providers in system 10 and finds three available in the service area 116. Alternatively, system 10 can make a request to providers to submit progress to meet the consumer request for a health program. Each program includes a package of initial physician consultations, preventive care services including dietary and nutritional support, exercise programs, home-based weight and vital sign monitoring and quarterly physician visits 118. System 10 can require that providers submitting proposed health care programs include a subset of these services. Consumer selects or accepts one of the programs 120 (by, for example, clicking on a display element on a client computer) and schedules 122, 124 an initial physician visit based on lowest cost. Payment is made through a combination of a health savings account, a checking account and a credit card.

A confirmation printout is provided that includes payment receipt, appointment details, services purchased breakdown, and driving directions to the place of care.

### EXAMPLE 4

Consumer desires to purchase an executive physical and to coordinate travel with the physician visit. Consumer logs into his myhealthecare.com account and searches for executive physicals in Florida and Arizona in February 130.

The application finds and sorts all executive physicals within the requested criteria 132, which are displayed 132 as packaged programs including the physician appointment and travel-related data, such as air travel, car rental, and hotel reservation sorted by lowest price. Once the consumer selects a package and location 134, he is then queried to identify if any extra reservations must be made for plane tickets, hotel rooms, and car rental 136. Upon consumer authorization, the executive physical is paid for by the consumer's health savings account 138; however he is prompted to enter credit card information for payment of travel and lodging accommodations 92.

Finally a confirmation printout 94 is provided including payment receipt, appointment details, services purchased breakdown, and driving directions to the place of care.

Travel-related data can be accessible via a travel-related web site, such as Expedia.com, Travelocity.com, etc. Alternatively, travel-related opportunities can be packaged with or associated with a health care opportunity by a provider, particularly hotel services, and can be at a discount negotiated by the provider or by an administrator of system 10.

### EXAMPLE 5

A physician has excess capacity, reflected in open time slots in his appointment calendar and reduced gross revenue for the past several months. Logging in to his HealtheCare Marketplace account 138 through his practice management software 16 the physician queries system 10 at a prompt 140 to increase the number of back to school physicals that he is prepared to offer in the month of July and August, and adjusts his pricing profile, criteria or model to price at 5% under the market average for physicals 142.

Based on his increased inventory and reduced price position, the physician sees demand for his back-to-school physicals increase and his gross revenue increase as well 144.

### EXAMPLE 6

A dermatologist with a HealtheCare Marketplace account 138 offered as an integrated part of his practice management software package 16 is trained in a new cosmetic procedure. Prior to offering the procedure he runs a market report 146 of similarly available services in the market and receives a print-out 148 of pricing and availability within a 15-mile radius.

Based on the report 150, which includes average price of the procedure as offered by providers on HealtheCare, the physician sets his procedure price at 5% below market and includes a complimentary follow-up visit in the package 152, 154. He believes that this pricing strategy will generate volume and help him gain entry into the market and capture market share from his established competitors.

After six months time, and having sold 80 percent of his inventory of service, the physician resets his market profile to price at market rate as determined by an average of all similar procedures offered in his primary market through the HealtheCare system 10. The HealtheCare system 10 automatically reprices his inventory for him.

Advantageously, some embodiments will optimize utilization of capacity for some health care providers. In some embodiments, health savings accounts will be simplified so providers can be found easily, thereby making health savings accounts more usable. In some embodiments, the prices of health care opportunities will have flexibility based on time-value services, demand, and other criteria. In some embodiments, the marketing of a provider of services can be provided on the same screen as the purchasing opportunity, which can save marketing dollars for providers. In some embodiments, the computerized system enables price competition among health care providers.

While the exemplary embodiments illustrated in the FIGS. and described above are presently preferred, it should be understood that these embodiments are offered by way of example only. For example, many of the exchanges of data between the entities of FIG. 1 is electronic, but one or more of these exchanges may use other methods of communication, such as traditional paper communication, in alternative embodiments. Further, system 10 may be operated by an administrator and many of the communications between consumer 12 and system 10 may take place via administrator (for example, where a consumer does not have computer access, or where a consumer finds it easier to have the assistance of an administrator or other service providers in communicating with system 10). In this manner, the administrator or other service provide can act as a liaison between consumer 12 (or even providers 14 or other entities in FIG. 1) and system 10. Further, the steps in the methods and functions set forth are interchangeable and need not take place in the order recited. Further, system 10 can comprise only one or more of such methods and functions in order to realize some advantages of system 10. References in the claims to “a” or “an” element or limitation mean “at least one”. Accordingly, the present invention is not limited to a particular embodiment, but extends to various modifications that nevertheless fall within the scope of the appended claims.

What is claimed is:

1. In a computerized system allowing consumers to view health care opportunities from a plurality of different health care providers, a method comprising:
providing for viewing a health care opportunity offered by a health care provider, wherein the health care opportunity has a price; and
adjusting the price of the health care opportunity based on at least one preprogrammed criteria.

2. The method of claim 1, wherein the health care opportunity has an appointment date and time, wherein the criteria include a time-based criteria and the price is adjusted based on the appointment time.

3. The method of claim 1, wherein the criteria include a market-based criteria and the price is adjusted based on a supply of or demand for other health care opportunities provided for viewing on the computerized system.

4. The method of claim 3, wherein the criteria include a second market-based criterion representing a quality characteristic of the health care provider offering the other health care opportunities, wherein the price is only adjusted in response to the supply of or demand for other health care opportunities offered by providers having a predetermined quality characteristic.

5. The method of claim 1, wherein the criteria include a market-based criteria and the price is adjusted based on prices of other health care opportunities provided for viewing on the computerized system.

6. The method of claim 1, wherein the computerized system is configured to receive a request to accept the health care opportunity.

7. The method of claim 6, wherein the computerized system is configured to facilitate payment for the health care opportunity.

8. The method of claim 1, further comprising receiving the at least one preprogrammed criteria from the health care provider.

9. In a computerized system for matching a health care request from a consumer with a health care opportunity from a provider, a method comprising:
providing a user interface to a consumer, wherein the user interface is configured to receive a request from a consumer for a health care opportunity;
receiving a health care opportunity from a provider;
providing the health care opportunity to the consumer for viewing if the health care opportunity meets the health care request;
receiving from the consumer a request to accept the health care opportunity; and
facilitating payment to the provider of the accepted health care opportunity.

10. The method of claim 9, further comprising providing an alert to the consumer if the health care opportunity meets the health care request.

11. The method of claim 10, wherein the alert comprises an e-mail message sent to the consumer.

12. The method of claim 9, wherein the user interface is configured to receive a request from a consumer for a health care program comprising a plurality of health care services.

13. The method of claim 12, wherein the user interface is configured to receive a request from a consumer for a health care program directed to improving general health.

14. The method of claim 12, wherein the user interface is configured to receive a request from a consumer for a health care program directed to managing a chronic condition.

15. The method of claim 9, wherein the health care opportunity is received from the provider before the computerized system receives the consumer request.

16. A computer program stored on a computer-readable medium for use by a health care provider, comprising:
a practice management program configured to facilitate management of the health care provider's practice; and
an interface program configured to provide communication between the practice management program and a computerized system allowing consumers to view health care opportunities from a plurality of different health care providers.

17. The computer program of claim 16, wherein the interface program is configured to provide health care opportunities from the practice management program to the computerized system.

18. The computer program of claim 16, wherein the interface program is configured to provide confirmation of a scheduled appointment to a consumer via the computerized system.

19. The computer program of claim 16, wherein the interface program is configured to facilitate electronic transfer of funds from a consumer account on the computerized system to an account associated with the health care provider.

20. The computer program of claim 16, wherein the interface program is configured to provide clinical results to the consumer via the computerized system.
